(19) United States
(12) Patent Application Publication
(10) Pub. No.: US 2012/0044148 A1
(43) Pub. Date: Feb. 23, 2012

(54) APPARATUS AND METHOD FOR PERFORMING WORD SPACING IN A PORTABLE TERMINAL

(75) Inventors: Chang-Woo LEE, Gyeongsangbuk-do (KR); Jae-Ik JUNG, Daegu (KR); Young-Hae KIM, Gyeonggi-do (KR); Won-Kyung SEONG, Gyeongsangbuk-do (KR); Jong-Wu BAEK, Gyeongsangbuk-do (KR)

(73) Assignee: SAMSUNG ELECTRONICS CO., LTD., Gyeonggi-Do (KR)

(21) Appl. No.: 13/212,265

(22) Filed: Aug. 18, 2011

(30) Foreign Application Priority Data
Aug. 18, 2010 (KR) 10-2010-0079868

(51) Int. Cl. G06F 3/02

(52) U.S. Cl. 345/169

(57) ABSTRACT

Disclosed is an apparatus and a method capable of performing a word spacing function without a separate key input for the word spacing in a portable terminal. The method includes determining interval duration for which a key is pressed; and displaying data assigned to the pressed key and performing a word spacing function when the key is pressed for a duration equal to or more than a predetermined time interval.

### CLAIM OF PRIORITY

This application claims priority under 35 U.S.C. §119 to a Korean Patent Application entitled “Apparatus and Method for Performing Word Spacing in Portable Terminal” filed in the Korean Intellectual Property Office on Aug. 18, 2010 and assigned Serial No. 10-2010-0079868, the contents of which are incorporated herein by reference.

### BACKGROUND OF THE INVENTION

1. Field of the Invention

The present invention relates to an apparatus and a method for performing word spacing in a portable terminal, and more particularly to an apparatus and a method capable of performing a word spacing function without a separate key input in a portable terminal.

2. Description of the Related Art

In today's society, a mobile portable terminal has become one of modern life necessities. The portable terminal provides various functions including a conventional communication function and text message transmission/reception function.

However, since the size of the portable terminal is limited in efforts to keep it small, a method of inputting letters by the portable terminal became complicated.

A key input unit of the portable terminal includes a separate space key for a word spacing function. Therefore, a user experiences inconvenience in that the user must press not only keys for letter input but also the space key for the word spacing function while inputting letters.

### SUMMARY OF THE INVENTION

Accordingly, the present invention has been made to solve the above-mentioned problems occurring in the prior art and provides additional advantages, by providing an apparatus and a method capable of performing a word spacing function without requiring a separate key input in a portable terminal.

In accordance with an aspect of the present invention, an apparatus for performing word spacing in a portable terminal includes: a key input unit having multiple keys, in which data assigned to each activated key is caused to be displayed and a word spacing function is caused to be performed when each key is pressed for a time interval equal to or more than a predetermined time interval; and a controller for displaying the data assigned to each activated key and performing the word spacing function when each key is pressed for the time interval equal to or more than the predetermined time interval.

In accordance with another aspect of the present invention, a method for performing word spacing in a portable terminal includes: determining a time interval for which a key is pressed; and displaying data assigned to the pressed key and performing a word spacing function when the key is pressed for a time interval equal to or more than a predetermined time interval.

In accordance with another aspect of the present invention a mobile terminal includes an input unit having a plurality of keys, in which data assigned to each activated key is displayed in a display unit and a word spacing is performed between data when one of the plurality of keys is activated for a duration equal to or longer than a predetermined time interval, and a controller for displaying the data assigned to each activated key and performing the word spacing when one of the plurality of keys is pressed for the duration equal to or more than the predetermined time interval. The controller is further configured to display data corresponding to each activated key when the duration is less than the predetermined time interval.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a block diagram illustrating the configuration of a portable terminal according to an exemplary embodiment of the present invention; and

FIG. 2 is a flowchart showing an operation for performing word spacing in a portable terminal according to an exemplary embodiment of the present invention.

### DETAILED DESCRIPTION OF THE INVENTION

Hereinafter, exemplary embodiments of the present invention will be described in detail with reference to the accompanying drawings. It should be noted that the same or equivalent elements are denoted by the same reference numerals in the drawings even though they are illustrated in the different drawings.

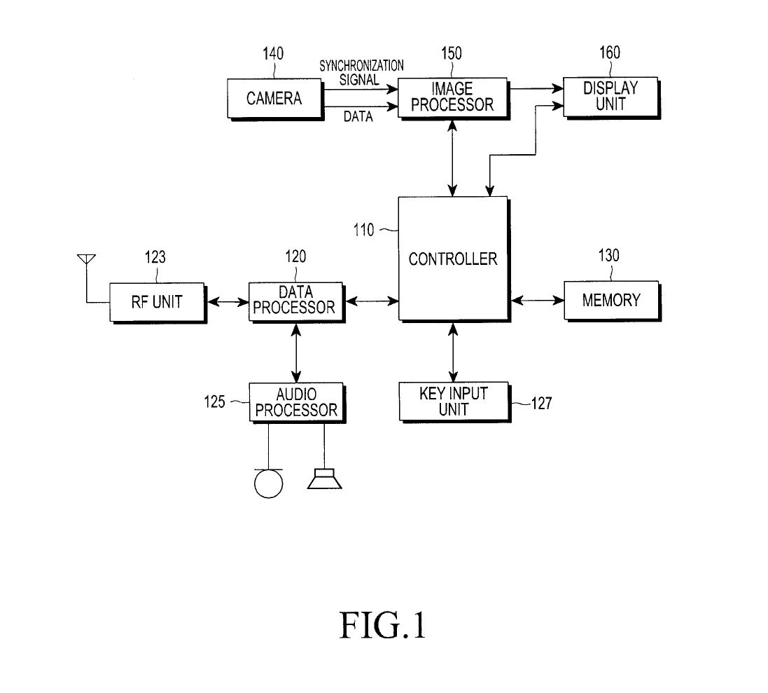

FIG. 1 is a block diagram illustrating the configuration of a portable terminal according to an exemplary embodiment of the present invention.

Referring to FIG. 1, a Radio Frequency (RF) unit 123 performs a function for wireless communication in a portable terminal. The RF unit 123 includes an RF transmitter for up-converting the frequency of a signal to be transmitted and amplifying the frequency up-converted signal, an RF receiver for low-noise amplifying a received signal and down-converting the frequency of the received signal, etc. A data processor 120 includes a transmitter for encoding and modulating the signal to be transmitted, a receiver for demodulating and decoding the received signal, etc. Namely, the data processor 120 may include a modem (modulator/demodulator) and a codec (coder/decoder). In this case, the codec includes a data codec for processing packet data, etc., and an audio codec for processing an audio signal such as voice. The audio processor 125 reproduces a received audio signal provided by the audio codec of the data processor 120, or provides the audio codec of the data processor 120 with a transmission audio signal generated from a microphone.

A key input unit 127 includes a plurality of keys for inputting numbers and letters, and function keys for setting various functions. It should be noted that a touch pad type or trackpad type screen can be used to input data according to the embodiment of the present invention.

According to the teachings of the present invention, the key input unit 127 includes multiple keys, in which data assigned to each pressed key of the multiple keys can be caused to be displayed and a word spacing function can be caused to be performed when each key is pressed for a time interval equal to or more than a predetermined time interval according to an exemplary embodiment of the present invention, and in which data assigned to each pressed key can be caused to be displayed when each key is pressed for a time interval less than the predetermined time interval. Here, the data includes letters, numbers, special letters, etc. assigned to the keys.

A memory 130 may include a program memory and a data memory. The program memory may store programs for controlling usual operations of the portable terminal, and programs which run so that the key input unit 127 may cause the data assigned to a pressed key to be displayed and then may cause the word spacing function to be performed when the key thereof is pressed for a time interval equal to or more than the predetermined time interval according to the exemplary embodiment of the present invention. Further, the data memory temporarily stores data generated while the programs run.

The controller 110 controls overall operations of the portable terminal.

In operation, when a key of the key input unit 127 is pressed for a time interval equal to or more than the predetermined time interval, the controller 110 displays the data assigned to the pressed key through a display unit 160, and then performs the word spacing function.

Meanwhile, when a key of the key input unit 127 is pressed for a time interval less than the predetermined time interval, the controller 110 displays data assigned to the pressed key through the display unit 160.

A camera 140, which captures image data, includes a camera sensor for converting a captured light signal to an electrical signal, and a signal processor for converting an analog image signal, which corresponds to the electrical signal provided by the camera sensor, to digital data. In this case, the camera sensor is assumed to be a CCD (Charge-Coupled Device) or a CMOS (Complementary Metal Oxide Semiconductor) sensor, and the signal processor may be implemented as a DSP (Digital Signal Processor). Alternatively, the camera sensor may be implemented as one body with the signal processor. Moreover, the camera sensor may be implemented separately from the signal processor.

An image processor 150 performs Image Signal Processing (ISP) so that the display unit 160 may display an image signal provided by the camera 140. The ISP performs functions, including a gamma correction, an interpolation, a spatial variation, an image effect, an image scale, an Auto White Balance (AWB), an Auto Exposure (AE), an Auto Focus (AF), etc. Therefore, the image processor 150 processes an image signal provided by the camera 140 on a frame-by-frame basis, and provides the frame image data in order to fit the characteristics and the size of the display unit 160. Also, the image processor 150 includes a video codec, and performs a function for compressing frame image data, which is displayed by the display unit 160, in a set scheme, or performs a function for restoring compressed frame image data to the original frame image data. In this case, the video codec may be a JPEG (Joint Photographic Experts Group) codec, an MPEG-4 (Moving Picture Experts Group-4) codec, a Wavelet codec, etc. The image processor 150 is assumed to have an OSD (On Screen Display) function, and can output OSD data according to a displayed screen size under the control of the controller 110.

The display unit 160 displays an image signal, which is provided by the image processor 150, on a screen thereof, and displays user data, which is provided by the controller 110, on the screen thereof. The display unit 160 may employ an LCD (Liquid Crystal Display). In this case, the display unit 160 may include an LCD controller, a memory capable of storing image data, an LCD element, etc. When the LCD is implemented in a scheme for touch-screen, the display unit 160 may operate as an input unit, and therefore may display the same keys as the key input unit 127 includes. Note that a touch pad can be integrated into the display unit to input data by a user.

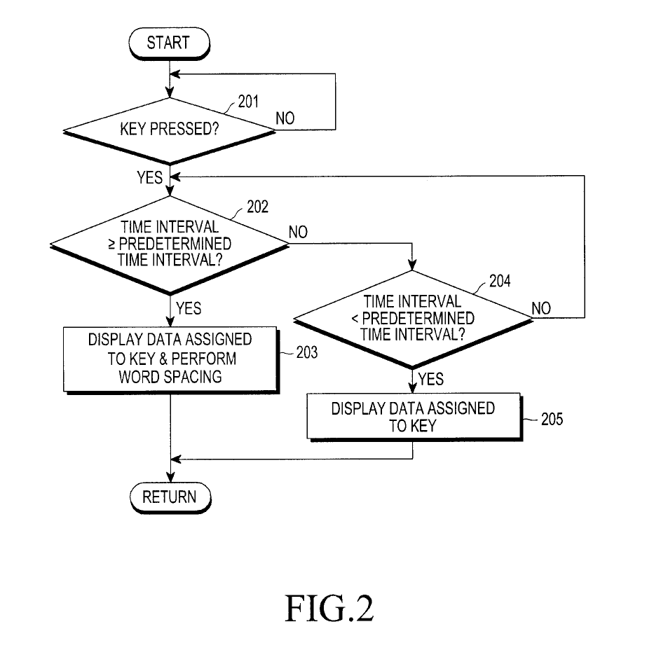

Now, an operation of performing word spacing in a portable terminal as described above will be described in detail with reference to FIG. 2.

FIG. 2 is a flowchart showing an operation for performing word spacing in a portable terminal according to an exemplary embodiment of the present invention.

Referring to FIG. 2, a user can input letters through multiple keys included in the key input unit 127(or via a touch pad) in a letter input mode of the portable terminal.

When a particular key of the multiple keys in the key input unit 127 is pressed during the letter input mode, the controller 110 detects the pressing/activation of the particular key, and determines a duration for which the particular key is pressed/activated (step 201).

When the particular key is pressed for a duration equal to or more than a predetermined time interval, the controller 110 detects that the particular key is pressed for a time interval equal to or more than the predetermined time interval (step 202). Then, it proceeds to step 203 for displaying data, which is assigned to the particular pressed key, through the display unit 160 and performs a word spacing function for moving a cursor to the next space.

However, when the particular key is pressed for a time interval less than the predetermined time interval, the controller 110 detects that the particular key is pressed for a time interval less than the predetermined time interval (step 204). Then, it proceeds to step 205 for only displaying the data, which is assigned to the particular pressed key, through the display unit 160.

When the user presses a key, which is pressed just before performing the word spacing function, for a time interval equal to or more than the predetermined time interval without a separate key input for the word spacing in the letter input mode, the repeated performance of steps 201 to 205 enables the user to input letters while displaying data assigned to the pressed key and immediately performing the word spacing function.

In the past, when “Nice meet you” is input by using a conventional key input unit, a key assigned “N,” a key assigned “i,” a key assigned “c” and a key assigned “e” must be sequentially pressed, and then a space key for performing the word spacing function must be pressed; a key assigned “m,” a key assigned “e,” the key assigned “e” and a key assigned “t” must be sequentially pressed, and then the space key for performing the word spacing function must be pressed; and a key assigned “y,” a key assigned “o” and a key assigned “u” must be sequentially pressed.

However, when “Nice meet you” is input by using the key input unit according to the exemplary embodiment of the present invention, without separately pressing a space key, a key assigned “N,” a key assigned “i” and a key assigned “c” are sequentially pressed, and then a key assigned “e” is pressed for a time interval equal to or more than a predetermined time interval; a key assigned “m,” a key assigned “e” and the key assigned “e” are sequentially pressed, and then a key assigned “t” is pressed for a time interval equal to or more than the predetermined time interval; and a key assigned “y” and a key assigned “o” are sequentially pressed, and then a key assigned “u” is pressed for a time interval equal to or more than the predetermined time interval. By doing this, the user can conveniently input the data as it reduces the required typing of a separate space key during texting.

By providing an apparatus and a method for performing word spacing in a portable terminal according to the present invention, data can be conveniently input without using a separate key for word spacing. Also, it is possible to help the miniaturization of the portable terminal in that the portable terminal need not include the separate key for the word spacing.

Note that the above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

While the invention has been shown and described with reference to certain exemplary embodiments thereof including a specific embodiment such as a portable terminal, it will be understood by those skilled in the art that various changes in form and details may be made therein without departing from the spirit and scope of the invention. Therefore, the spirit and scope of the present invention must be defined not by the described embodiments thereof but by the appended claims and equivalents of the appended claims.

What is claimed is:

1. An apparatus for performing word spacing in a portable terminal, comprising:
an input unit having multiple keys, in which data assigned to each pressed key of the multiple keys is displayed and a word spacing function is performed when each key is pressed for a time interval equal to or more than a predetermined time interval; and
a controller for displaying the data assigned to each pressed key and performing the word spacing function when each key is pressed for the time interval equal to or more than the predetermined time interval.

2. The apparatus as claimed in claim 1, wherein each of the multiple keys in the key input unit causes data assigned to each pressed key to be displayed when each key is pressed for a time interval less than the predetermined time interval.

3. The apparatus as claimed in claim 1, wherein the controller displays data assigned to each pressed key when each key is pressed for a time interval less than the predetermined time interval.

4. The apparatus as claimed in claim 1, wherein key input unit comprises a touch pad.

5. A method for performing word spacing in a portable terminal, the method comprising:
determining a time interval for which a key is pressed; and
displaying data assigned to the pressed key and performing a word spacing function when the key is pressed for a time interval equal to or more than a predetermined time interval.

6. The method as claimed in claim 5, which further comprises displaying the data assigned to the pressed key when the key is pressed for a time interval less than the predetermined time interval.

7. A mobile terminal, comprising:
an input unit having a plurality of keys, in which data assigned to each activated key is displayed in a display unit and a word spacing is performed between data when one of the plurality of keys is activated for a duration equal to or longer than a predetermined time interval; and
a controller for displaying the data assigned to each activated key and performing the word spacing when one of the plurality of keys is pressed for the duration equal to or more than the predetermined time interval.

8. The terminal as claimed in claim 7, wherein the controller is configured to display data corresponding to each activated key when the duration is less than the predetermined time interval.

9. The terminal as claimed in claim 1, wherein the input unit comprises a touch pad.
